(19) United States
(12) Patent Application Publication
(10) Pub. No.: US 2023/0323903 A1
(43) Pub. Date: Oct. 12, 2023

(54) Tunable, Pulsatile, and 3-Dimensional Fluidic Oscillator

(71) Applicant: BOARD OF REGENTS, THE UNIVERSITY OF TEXAS SYSTEM, Austin, TX (US)

(72) Inventors: LEONID BUNEGIN, San Antonio, TX (US); ZACHARY FALLON, San Antonio, TX (US); CHRISTOPHER COMBS, San Antonio, TX (US); DANIEL PORTILLO, San Antonio, TX (US); Lyle R. Hood, San, TX (US)

(21) Appl. No.: 18/022,742

(22) PCT Filed: Aug. 14, 2021
(86) PCT No.: PCT/US2021/046052

§ 371 Date: Feb. 22, 2023

Related U.S. Application Data
(60) Provisional application No. 63/066,050, filed on Aug. 14, 2020.

(51) Int. Cl. F15D 1/00

(52) U.S. Cl. CPC F15D 1/0095

(57) ABSTRACT

Novel fluidic oscillator (FO) designs that can incorporate features to allow for performance tunability and pulsatile outlet flow. Novel fluidic designs that utilize 3D space are also incorporated. All novel design features mentioned herein can be combined in any fashion with each other.

### PRIORITY PARAGRAPH

This Application claims priority to U.S. Provisional Patent Application Ser. No. 63/066,050 filed Aug. 14, 2020, which is incorporated herein by reference in its entirety.

### STATEMENT REGARDING FEDERALLY FUNDED RESEARCH

This invention was made with government support under PRMRP Award Number W81XWH-18-1-0640 awarded by the Department of Defense. The government has certain rights in the invention.

### BACKGROUND

A fluidic oscillator (FO), sometimes referred to as a sweeping jet actuator, is a channel geometry that turns a steady stream of fluid flow into an oscillating stream of flow. The oscillations are cause by the Coanda effect, which describes the behavior of the fluid attaching to the walls of the channel. The geometry of the FO channel, which provides space for the fluid to attach and detach from the walls, causes vortices to form and perpetuate, thus creating an oscillating flow. These designs tend to be complicated in two dimensions with a fairly constant height in the third.

FOs were conceptualized in the 1960's. They were created with the intent of operating a control system based on fluid logics, later termed fluidics. While FOs were gaining popularity in the field of systems controls, so was the electronic transducer. For various reasons, the electronic transducer proved to be more effective in the systems controls field, and the FOs that were developed were mainly used for spray or nozzle purposes. FOs can now be found in some nozzles in shower heads, water hose attachments, and windshield fluid dispensers.

However, due to recent advancements in computational fluid dynamics (CFD), FOs are being reevaluated from alternative perspectives. FOs are now being evaluated for applications in heat exchangers, fuel mixing, flow measurements, and aircraft. In the envisioned implementation, a FO is designed to regulate pressure and fluid flow in a medical device. Unfortunately, none of the previous FOs provide the tunability and pulsatile flow at the exit port required. A tunable and/or pulsatile FO could also prove useful in many fields and applications, including all those previously mentioned. The following section summarizes the basis of the fluidic oscillator designs and also includes, for the purpose of broader applications, designs that utilize the third spatial dimension.

### SUMMARY

To address the first requirement listed in the previous section, a novel design of a FO with adjustable parts was pursued. Existing FO geometries are fabricated in a manner that does now allow their geometry to be altered at need after fabrication. Published literature shows that if some of the geometric features are altered in the design process, while the other geometric features are kept constant, the fluid oscillator performance will change [1-6]. A solution is to fabricate a FO with components that allow various geometries to be altered after fabrication is complete. An example would be to fabricate a FO's feedback channels in a manner that allows them to be lengthened or shortened.

A novel design of a FO that produces pulsatile flow was pursued. Some FO designs exist that produce a bi-stable pulsed flow. These FOs capture the oscillating exit flow and direct it to two outlets, which ultimately produces an alternating, or bistable, pulsed flow at each of the outlets. One enclosed design captures the oscillating flow, or part of it, and directs it through a single outlet.

In the process of conceptualizing and fabricating novel FO designs, designs that more actively incorporated the third dimension were developed. The complex features of existing FO geometries are designed in the x-y plane, and then simply raised vertically in the z-direction to create a channel. We have created designs that incorporate complex features in the entire x-y-z space.

It should be documented that all of the novel solutions and designs previously discussed can be exclusively, partially, or collectively incorporated. For example, a novel design for our application can incorporate both tunable and pulsatile features.

Certain embodiments are directed to a fluid oscillator (FO) device comprising a body forming a first fluid channel configured for mixing or vortex formation, the body having at least one inlet to the channel at the proximal end of the body, at least one outlet to the channel at the distal end of the body, and at least one feedback channel configured to form at least a second fluid channel with a feedback inlet in fluid communication with the first fluid channel the feedback inlet being positioned proximal to the at least one outlet and a feedback outlet in fluid communication with the first fluid channel positioned distal to the at least one inlet, wherein, when in use, an oscillating fluid flow, a pulsatile fluid flow, or an oscillating and pulsatile fluid flow is created from a steady or constant fluid stream. In certain aspects the feedback channels, return channels, inlet channels, or outlet channels can independently have diameters of 0.1, 1, 10, 20, 30, 40, 50, 60, 70, 80, 90, to 100 μm, mm, cm, dm, or m including all values and ranges there between. In certain aspects the feedback channels, return channels, inlet channels, or outlet channels can independently have lengths of 0.1, 1, 10, 20, 30, 40, 50, 60, 70, 80, 90, to 100 μm, mm, cm, dm, or m including all values and ranges there between. In certain aspects the mixing/vortex channel can have diameters of 0.1, 1, 10, 20, 30, 40, 50, 60, 70, 80, 90, to 100 μm, mm, cm, dm, or m including all values and ranges there between. In certain instances, the mixing/vortex channel has a diameter that varies along its length. In certain aspects the features, e.g., feed back channels and/or the mixing/vortex channel can be modified or adjusted (e.g., there length or configuration altered) post fabrication. In certain aspects the features produce a single pulsatile outlet flow. The first fluid channel, the feedback fluid channel or the first fluid channel and the feedback fluid channel can be modified or adjusted (e.g., there length or configuration altered) post fabrication. The device can be configured to produce a single pulsatile outlet flow. The modification or adjustment can be by sliding, extending, shortening, or twisting of a feature. In certain aspects that modified or adjusted feature is a feedback fluid channel, a mixing/vortex channel, or a fluid channel and a mixing or vortex channel.

A device described herein can be configured in the three primary spatial directions, three-dimensional device. The features of the three-dimensional device can be modified post fabrication. The three-dimensional device can be configured to produce a single pulsatile outlet flow. The features of the three-dimensional device can be modified post fabrication and the device produces a single pulsatile outlet flow during operation. The three dimensional device can comprise a plurality of feedback fluid channels. The plurality of feedback fluid channels can be positioned radially about the first fluid channel or the mixing/vortex channel.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to all aspects of the invention. It is contemplated that any embodiment discussed herein can be implemented with respect to any method or composition of the invention, and vice versa. Furthermore, compositions and kits of the invention can be used to achieve methods of the invention.

The use of the word “a” or “an” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

As used herein, the terms “comprises,” “comprising,” “includes,” “including,” “has,” “having,” “contains”, “containing,” “characterized by” or any other variation thereof, are intended to encompass a non-exclusive inclusion, subject to any limitation explicitly indicated otherwise, of the recited components. For example, a chemical composition and/or method that “comprises” a list of elements (e.g., components or features or steps) is not necessarily limited to only those elements (or components or features or steps), but may include other elements (or components or features or steps) not expressly listed or inherent to the chemical composition and/or method.

As used herein, the transitional phrases “consists of” and “consisting of” exclude any element, step, or component not specified. For example, “consists of” or “consisting of” used in a claim would limit the claim to the components, materials or steps specifically recited in the claim except for impurities ordinarily associated therewith (i.e., impurities within a given component). When the phrase “consists of” or “consisting of” appears in a clause of the body of a claim, rather than immediately following the preamble, the phrase “consists of” or “consisting of” limits only the elements (or components or steps) set forth in that clause; other elements (or components) are not excluded from the claim as a whole.

As used herein, the transitional phrases “consists essentially of” and “consisting essentially of” are used to define a chemical composition and/or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

FIGS. 1A-C. Illustrations of FO with adjustable feedback channel lengths. (FIG. 1A), illustration of FO when feedback channels are contracted. (FIG. 1B), illustration of FO when feedback channels are expanded. (FIG. 1C) illustration of FO with adjustable feedback channel lengths from isometric viewpoint.

FIGS. 2A-C. Illustrations of FO with adjustable mixing/vortex channel length. (FIG. 2A), illustration of FO when mixing/vortex channel is contracted. (FIG. 2B), illustration of FO when mixing/vortex channel is expanded. (FIG. 2C) illustration of FO with adjustable mixing/vortex channel length from isometric viewpoint.

FIGS. 3A-E. Illustrations of FO with adjustable feedback channel lengths and adjustable mixing/vortex channel length. (FIG. 3A), illustration of FO when feedback channels are contracted and mixing/vortex channel is contracted. (FIG. 3B), illustration of FO when feedback channels are expanded and mixing/vortex channel is contracted. (FIG. 3C), illustration of FO when feedback channels are contracted and mixing/vortex channel is expanded. (FIG. 3D), illustration of FO when feedback channels are expanded and the mixing/vortex channel is expanded. (FIG. 3E), illustration of FO with adjustable feedback channel lengths and adjustable mixing/vortex channel length from isometric viewpoint.

FIGS. 4A-C. Illustrations of FO with adjustable feedback channel lengths and adjustable mixing/vortex channel length. (FIG. 4A), illustration of FO when feedback channels are contracted and mixing/vortex channel is contracted. (FIG. 4B), illustration of FO when feedback channels are expanded and mixing/vortex channel is expanded. (FIG. 4C), illustration of FO with adjustable feedback channel lengths and adjustable mixing/vortex channel length from isometric viewpoint.

FIGS. 5A-B. Illustrations of FO designed to supply pulsatile flow. (FIG. 5A), illustration of FO designed to supply pulsatile flow from top viewpoint. (FIG. 5B), illustration of FO designed to supply pulsatile flow from front viewpoint.

FIG. 6. Illustration of FO, with two feedback channels, designed to supply pulsatile flow.

FIG. 7. Illustration of FO, with a single feedback channel, designed to supply pulsatile flow.

FIG. 8. Illustration of FO with adjustable feedback channel lengths designed to supply pulsatile flow.

FIG. 9A-E. Illustrations of FOs designed in 3D space. (FIG. 9A), illustration of existing 2D FO design. (FIG. 9B), illustration of FO that incorporates rotated (2× by 90°) geometries of the FO design shown in FIG. 9A. (FIG. 9C), illustration of FO that incorporates rotated (3× by 60°) geometries of the FO design shown in FIG. 9A. (FIG. 9D), illustration of FO that incorporates a fully rotated (360°) geometry of the FO design shown in FIG. 9A. (FIG. 9E), illustration of the cross-sectional view of the FO shown in FIG. 9D.

### DESCRIPTION

The following discussion is directed to various embodiments of the invention. The term “invention” is not intended to refer to any particular embodiment or otherwise limit the scope of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

There exists a need for FOs that have tunable fluid flow parameters and pulsation. This need is present across fields such as thermal regulation, aircraft design, wind turbine design, propulsion systems, fuel mixing, fluid mixing, flow sensing, and medical devices. There is also room for growth in the complexity of FOs as they have primarily been designed in two dimensions. The designs described herein aim to show how FOs can be improved and become more widely used.

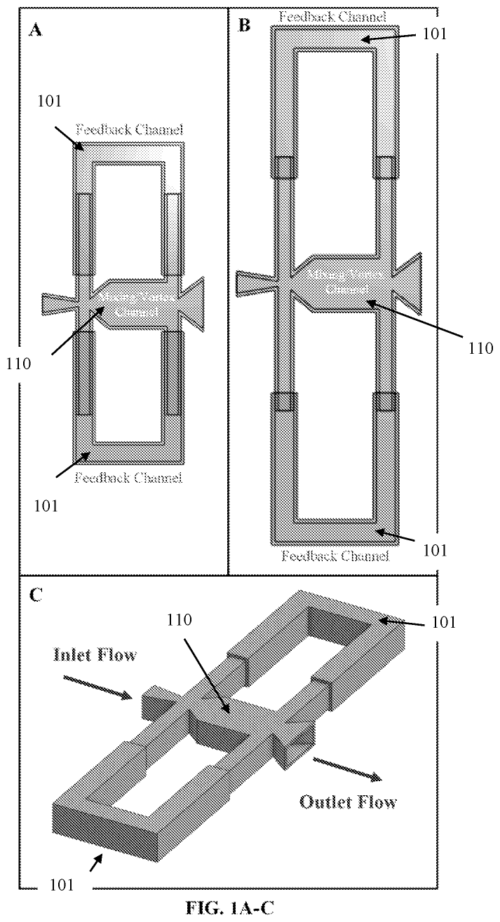

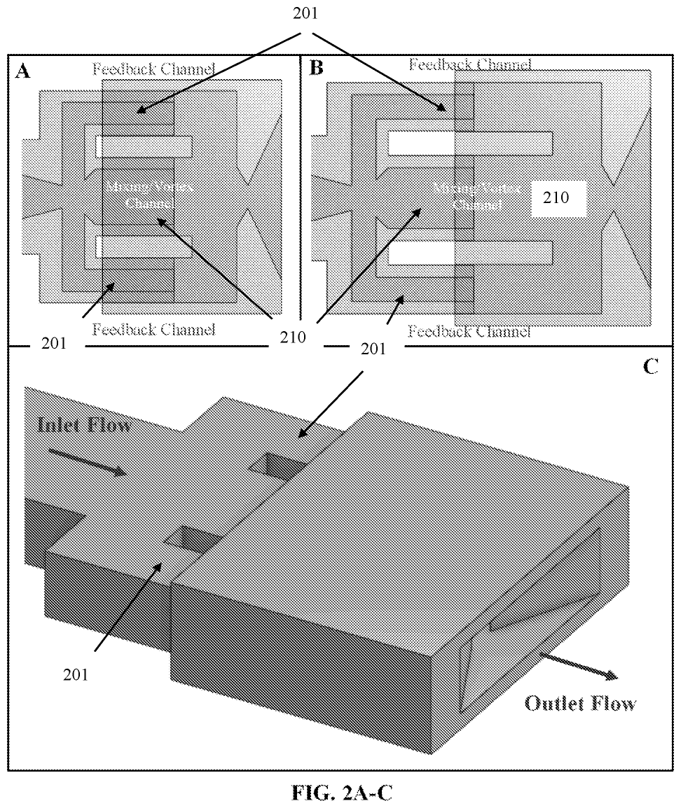

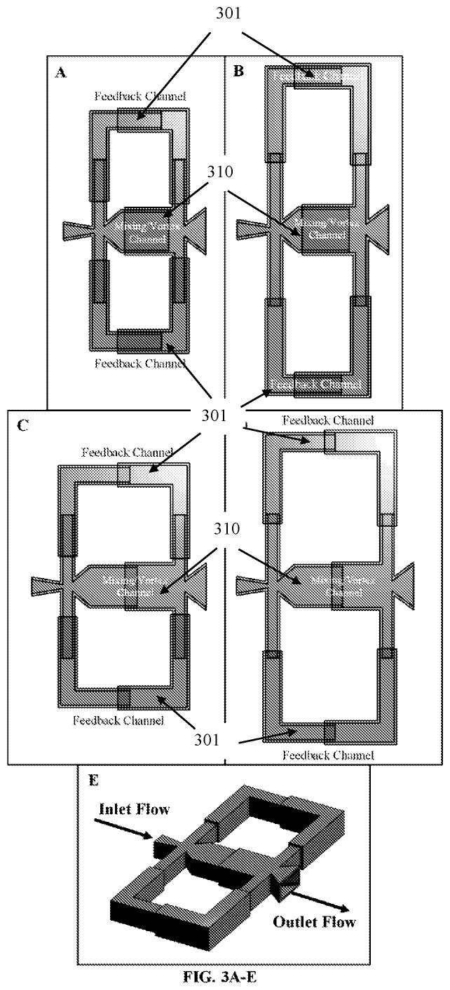

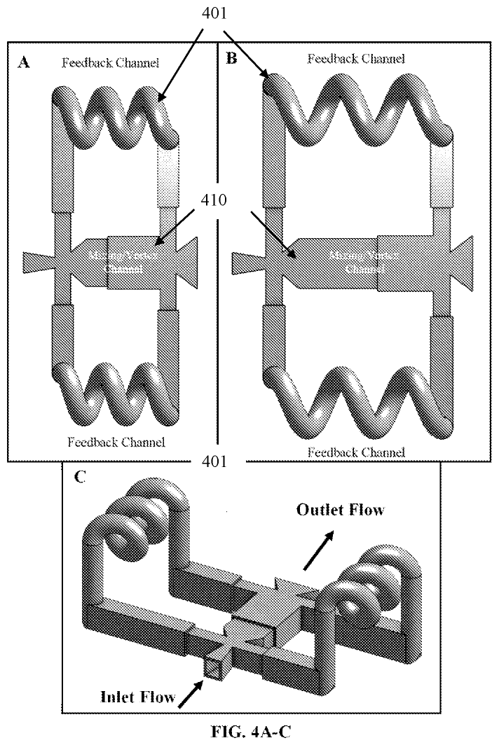

The main focus for creating an actively tunable FO is derived from altering the geometry of the FO during its operation/use. Multiple geometric features can be altered, and FIG. 1 provides illustrations of a FO with adjustable feedback channel lengths. The feedback channels 101 can be positioned to decrease (FIG. 1A) or increase (FIG. 1B) their length. FIG. 2 provides illustrations of a FO with an adjustable mixing/vortex channel 210. The mixing/vortex channel 210 can be positioned to decrease (FIG. 2A) or increase (FIG. 2B) its length. There also exists the possibility to alter multiple geometries within the same FO design. FIGS. 3 and 4 illustrate FO designs that incorporate adjustable feedback channels (301, 401) and vortex/mixing channels (310, 410). FIGS. 3A-D and FIGS. 4A-B illustrate various combinations of expansion and contraction of both the feedback channel length and mixing/vortex channel length.

While the components illustrated in FIGS. 1-4 are able to move, they will be fixed during operation/use of the FO. The means of expansion and contraction for both the feedback channels and mixing/vortex channel can be a sliding mechanism (FIGS. 1-3), twisting mechanism, or elongation mechanism (FIG. 4). In certain aspects, the device can be modified post fabrication by, for example, sliding to components, twisting components, or elongating/shortening components.

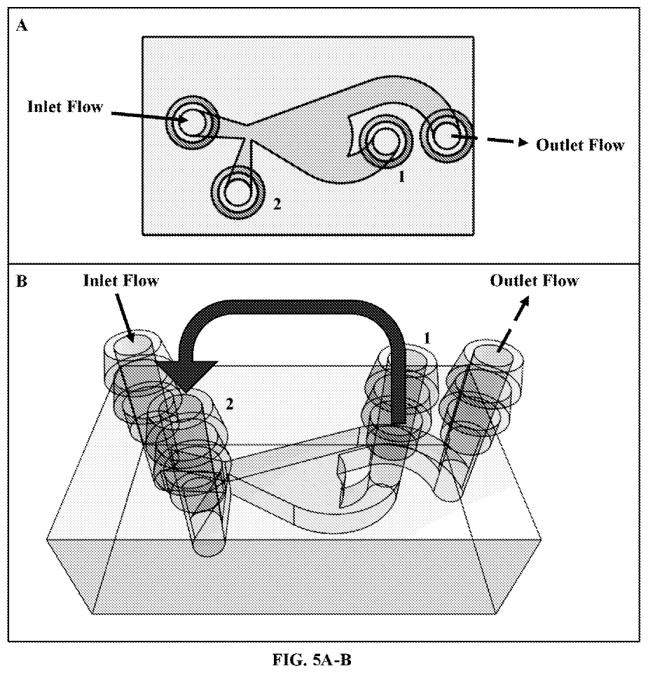

The operating concept for FOs that produce a pulsed flow is directing and isolating the flow exiting the mixing/vortex chamber. The design illustrated in FIG. 5 moves fluid naturally towards channel 1, which is fed to channel 2, which causes a diversion of the inlet flow to the outlet. Once the flow is exiting, it no longer fills the 1-2 channel, meaning that the inlet flow is not diverted and returns to filling the 1-2 channel. Once the 1-2 channel is flowing, it diverts inlet flow, thus creating oscillations.

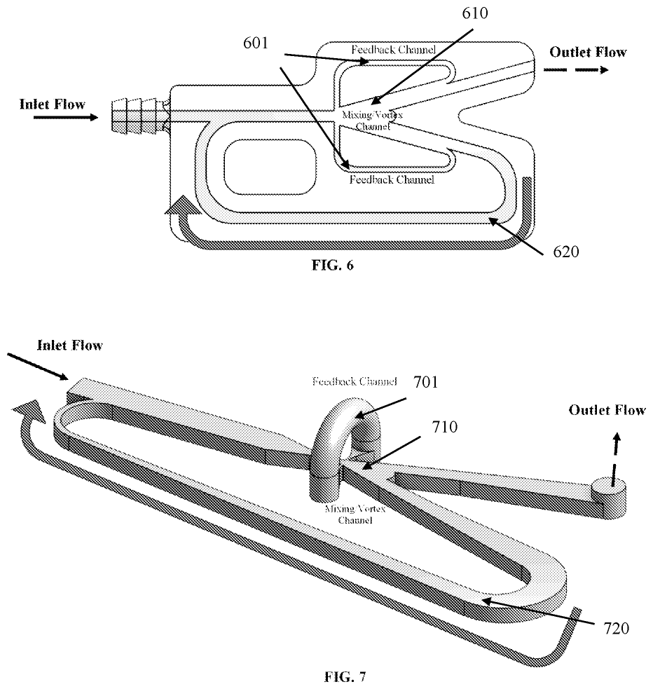

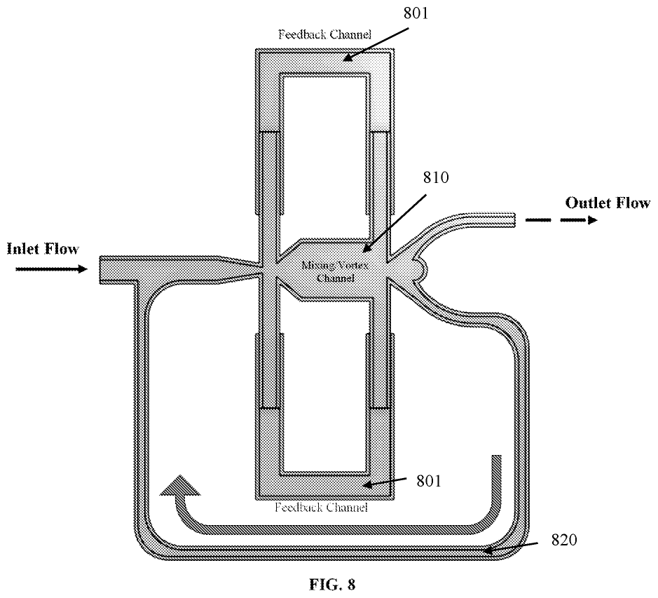

The designs illustrated in FIGS. 6 and 7 divert the oscillating flow from the mixing/vortex chamber (610, 710) to two channels. One of the channels reroutes the fluid back to the inlet of the FO (return channel 620, 720), and one of the channels allows the fluid to exit the FO (outlet channel). As the flow oscillates between each of the post-mixing/vortex channels, they will each experience pulsed flow (phase shifted by 180°). Furthermore, by only allowing one of the channels to exhaust, the entire outlet flow of the FO is pulsatile flow. The primary difference between the design illustrated in FIGS. 6 and 7 is that the design in FIG. 6 incorporates two feedback channels 601 and the design in FIG. 7 incorporates a single feedback channel 701 (in the vertical direction).

The novel features (allowing tunability or pulsatile flow) of the designs illustrated in FIGS. 1-7 can be incorporated into the same FO. The design illustrated in FIG. 8 incorporates adjustable feedback channels 801 as well as a post-mixing/vortex 810 return channel 820 that reroutes the fluid back to the inlet of the FO (shown with a blue arrow).

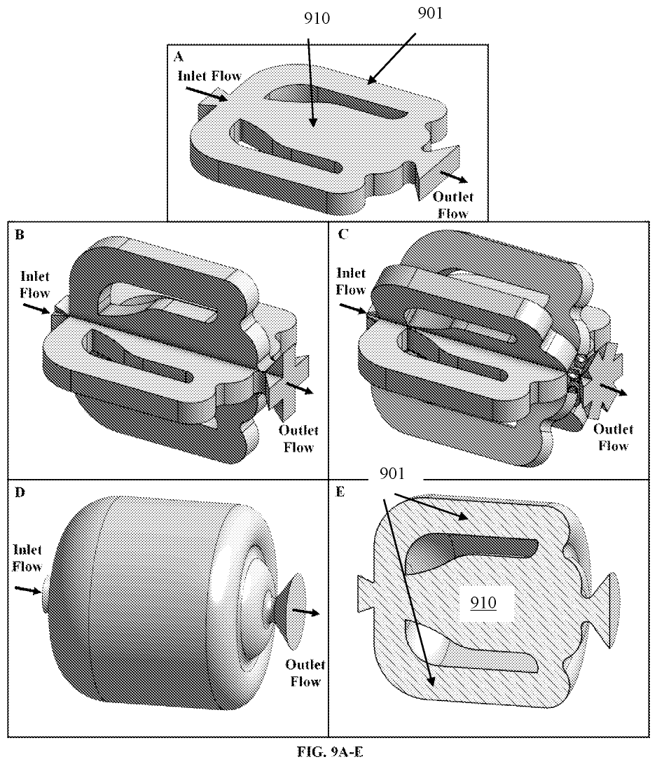

An even further extension of the possibilities of the previously discussed designs is to create them with features in a three-dimensional space. Most existing designs are primarily designed in a single plane (FIG. 9A) and extended/translated into the third dimension, but FIGS. 9B-D show that FOs can be designed in three dimensions. All of the novel features (allowing tunability or pulsatile flow) of the designs illustrated in FIGS. 1-7 can be incorporated into the FO designs illustrated in FIGS. 9B-D.

Every FO design previously described can be fabricated out of practically any metal, plastic, ceramic or other solid materials. Additionally, they can be manufactured in a variety of ways, including subtractive and additive manufacturing. The most common fabrication method incorporates machining/milling layers of a rigid material and then securing them together. Other common fabrication methods include molding or 3D printing. The scale of the FOs is limited only by the methods of manufacturing.

### REFERENCES

[1] Baghaei, M. and Bergada, J. M., 2020, “Fluidic Oscillators, the Effect of Some Design Modifications,” Applied Sciences, 10 (6), pp. 2105.

[2] Jeong, H.-S. and Kim, K.-Y., 2018, “Shape optimization of a feedback-channel fluidic oscillator,” Engineering Applications of Computational Fluid Mechanics, 12 (1), pp. 169-181.

[3] McDonough, J. R., Law, R., Kraemer, J., and Harvey, A. P., 2017, “Effect of geometrical parameters on flow-switching frequencies in 3D printed fluidic oscillators containing different liquids,” Chemical Engineering Research and Design, 117, pp. 1-18.

[4] Slupski, B. J. and Kara, K., 2016, “Effects of geometric parameters on performance of sweeping jet actuator,” 34th AIAA Applied Aerodynamics Conference, Washington, D. C.

[5] Campo, D. d., Bergada, J. M., and Campo, V. d., 2015, “Preliminary study on fluidic actuators. Design modifications.,” International Conference on Mechanics, Materials, Mechanical Engineering and Chemical Engineering, Barcelona, Spain.

[6] Bobusch, B. B., Woszidlo, R., Kruger, O., and Paschereit, C. O., 2013, “Numerical investigations on geometric parameters affecting the oscillation properties of a fluidic oscillator,” 21st AIAA Computation Fluid Dynamics Conference, San Diego, CA.

1. A fluid oscillator (FO) device comprising a body forming a first fluid channel configured for mixing or vortex formation, the body having at least one inlet to the channel at the proximal end of the body, at least one outlet to the channel at the distal end of the body, and at least one feedback channel configured to form at least a second fluid channel with a feedback inlet in fluid communication with the first fluid channel the feedback inlet being positioned proximal to the at least one outlet and a feedback outlet in fluid communication with the first fluid channel positioned distal to the at least one inlet, wherein, when in use, an oscillating fluid flow, a pulsatile fluid flow, or an oscillating and pulsatile fluid flow is created from a steady or constant fluid stream.

2. The device of claim 1, wherein features can be modified post fabrication.

3. The device of claim 1, wherein the features produce a single pulsatile outlet flow.

4. The device of claim 1, wherein the first fluid channel, the feedback fluid channel or the first fluid channel and the feedback fluid channel can be modified post fabrication.

5. The device of claim 4, wherein the device is configured to produce a single pulsatile outlet flow.

6. The device of claim 2, wherein modification is by sliding, extending, shortening, or twisting of a feature.

7. The device of claim 6, wherein the feature is a fluid channel.

8. The device of claim 1, wherein the device is configured in three primary spatial directions.

9. The device of claim 8, wherein features of the device can be modified post fabrication.

10. The device of claim 8, wherein the device is configured to produce a single pulsatile outlet flow.

11. The device of claim 8, wherein features can be modified post fabrication and the device produces a single pulsatile outlet flow during operation.

12. The device of claim 1 wherein a plurality of feedback fluid channels are positioned radially about the first fluid channel.
